(19) United States
(12) Patent Application Publication
(10) Pub. No.: US 2026/0351971 A1
(43) Pub. Date: Nov. 5, 2026

(54) METHOD AND APPARATUS FOR PREVENTING WASTE OF ENERGY

(71) Applicant: LIITTO TECHNOLOGY, INC., Palo Alto, CA (US)

(72) Inventors: Varun Palivela, Santa Clara, CA (US); William Layden, Brooklyn, NY (US); Benjamin Shuster, Canal Winchester, OH (US); Prasanna Nambi, San Jose, CA (US)

(73) Assignee: LIITTO TECHNOLOGY, INC., Palo Alto, CA (US)

(21) Appl. No.: 19/727,379

(22) Filed: Jul. 1, 2026

Related U.S. Application Data
(63) Continuation of application No. PCT/US2025/010241, filed on Jan. 3, 2025.
(60) Provisional application No. 63/618,129, filed on Jan. 5, 2024.

(51) Int. Cl. H02J 3/00; H02J 3/38; H02J 101/24; H02J 103/50; H02J 105/52; H02J 105/54; H02S 40/32

(52) U.S. Cl. CPC H02J 3/004; H02J 3/381; H02S 40/32; H02J 2101/24; H02J 2103/50; H02J 2105/52; H02J 2105/54

(57) ABSTRACT

A method and apparatus for dynamic use of excess energy that can include a solar array, an inverter with a maximum input power, a power controller, and computing elements, which can optionally comprise one or more servers, with programmable and/or flexible power consumption. The inverter can optionally be connected to the power grid. Because solar arrays are typically oversized relative to their inverters, power is lost or otherwise clipped when the array's output exceeds the inverter's maximum input power. By keeping track of the array's real-time output and adjusting the computing elements'power consumption, the power controller can maximize the use of power that would otherwise be clipped, curtailed, lost, wasted, or otherwise not used.

### CROSS-REFERENCE TO RELATED APPLICATIONS

This Application is a continuation of PCT/US2025/010241, entitled Method and

Apparatus for Preventing Waste of Energy, filed on Jan. 3, 2025, which itself claims priority to and the benefit of the filing of U.S. Provisional Patent Application No. 63/618,129, entitled “Method and Apparatus to Minimize Wasted Energy at a Solar or Wind Power Plant”, filed on Jan. 5, 2024, and the specification and claims thereof (if any) are incorporated herein by reference.

### BACKGROUND OF THE INVENTION

Embodiments of the present invention relate to a use of excess energy from a solar array, where an inverter, with a maximum input power, and a power controller reallocate excess energy to computing elements. The energy allocation method and apparatus can optionally include one or more servers, with programmable and/or flexible power consumption. The inverter can optionally be connected to a power grid.

Solar arrays generate direct current (“DC”). To connect a solar array to an alternating current (“AC”) grid, the generated DC power is converted to AC using an inverter. It is common practice with grid-connected and non-grid-connected solar plants to use inverters with a maximum input power that is less than the maximum output power of the attached solar array. This is because an inverter will typically turn “on” only at a power level that is a fixed fraction of its maximum rated output power. Thus, solar plants having smaller inverters will be able to capture more power when the sun is low in the sky. Further, solar panels degrade over time, thus producing comparatively lower power over their lifetime. In addition, because inverters are expensive relative to solar panels, cost savings are realized when using less powerful power inverters. When an array produces more power than its inverter can convert to AC, that excess power is lost (also occasionally referred to throughout this application as being “clipped”).

It is possible to capture power that would otherwise be clipped. For example, in the past, rudimentary techniques that use batteries for this purpose have been tried. See, for example, Eurek et al., “Representing DC-Coupled PV+Battery Hybrids in a Capacity Expansion Model,” NREL Technical Report NREL/TP-5C 00-77917 (April 2021).

Such known storage systems, however, are costly and have an inherent limitation on their amount of storage. Because of the cost of large-scale battery storage, it is not cost effective to install sufficient battery capacity to accommodate every foreseeable excess energy scenario. And, regardless of the size of battery bank that is installed, once it is full, it cannot store any further power and thus effectively fails to continue to absorb the excess power. There is thus a present need for a method and apparatus that does not merely store some excess power, but which instead can dynamically use the excess power.

### BRIEF SUMMARY OF EMBODIMENTS OF THE PRESENT INVENTION

Embodiments of the present invention relate to a method for allocating power to computing elements with the steps of: estimating a maximum power output for a solar array based on an output of one or more sensors; calculating a loss factor for the solar array; calculating an estimated usable power output of the solar array from the maximum power output of the solar array and the loss factor; calculating a clipped power value by periodically subtracting a maximum power input of an inverter from the estimated usable power output of the solar array; for each calculation of the clipped power value, if the result is both positive and greater than a minimum power consumption rate of at least one computing element, then supplying power to one or more of the computing elements and causing the one or more of the computing elements to consume a predetermined amount of power. Optionally, estimating a maximum power output for the solar array based on output of the one or more sensors can include calculating or estimating radiant flux based on the one or more sensors. In another embodiment, calculating the maximum power output of the solar array uses, as an input, a measured or estimated value of a temperature at the solar array. In another embodiment, calculating the maximum power output of the solar array uses, as an input, a measured or estimated wind speed at the solar array. In another embodiment, calculating the loss factor uses, as an input, a measured or estimated value of resistive losses in the solar array. In another embodiment, calculating the loss factor uses, as an input, a measured or estimated value of dust or debris buildup on the solar array. In another embodiment, calculating the loss factor further uses, as an input, a measured or estimated age of the solar array. In another embodiment, causing the one or more of the computing elements to consume a predetermined amount of power further includes programming an input voltage of one or more semiconductor chips. In another embodiment, causing the one or more of the computing elements to consume a predetermined amount of power further includes programming a clock frequency of one or more of the semiconductor chips. In another embodiment, causing the one or more of the computing elements to consume a predetermined amount of power uses, as an input, a measured temperature of one or more of the semiconductor chips. In another embodiment, the method further includes shutting off power to the computing elements if a calculated clipped power value is less than the minimum power consumption rate of at least one computing element. In another embodiment, the method further includes shutting off power to the computing elements if a power input to the inverter or a power output of the inverter drops by more than 1% for one minute or longer. In another embodiment, the method further includes shutting off power to the computing elements if more than 10% of the computing elements are malfunctioning. In another embodiment, the method further includes shutting off power to the computing elements if the measured or calculated value of radiant flux striking the solar array is unavailable. In another embodiment, the predetermined amount of power is at least substantially equal to the clipped power value.

Embodiments of the present invention also relate to a method for allocating power to power consuming elements that includes: estimating a maximum power output for a solar array; calculating a loss factor for the solar array; calculating an estimated usable power output of the solar array with the maximum power output of the solar array and the loss factor; calculating an available power value by periodically subtracting an estimated or actual power flow through a grid-connected inverter from the estimated usable power output of the solar array; for each calculation of the available power value, if the result is both positive and greater than a minimum power consumption rate of at least one power consuming element, then supplying power to one or more of the power consuming elements and causing the one or more of the power consuming elements to consume a predetermined amount of power. Optionally, estimating the maximum power output for the solar array can include measuring or estimating radiant flux striking the solar array.

In another embodiment, the estimated or actual power flow through the grid-connected inverter is equal to the grid-connected inverter's actual grid output plus estimated or actual losses from a DC-AC conversion performed by the inverter. In another embodiment, an estimate of power flow through the grid-connected inverter is based, at least in part, on a curtailment command received from a grid operator. In another embodiment, an estimate of power flow through the grid-connected inverter is based, at least in part, on a measured value of grid frequency. In another embodiment, an estimate of power flow through the grid-connected inverter is based, at least in part, on a calculation related to a current locational marginal price of electricity.

Embodiments of the present invention also relate to a solar panel energy allocation apparatus, including: a solar panel array with an alternating current (“AC”) side and a direct current (“DC”) bus bar; an inverter disposed between the AC side and DC bus bar; a power controller that calculates a clipped power value, wherein the clipped power value is calculated by periodically subtracting a maximum power input of the inverter from an estimated usable power output of the solar panel array; and a computing element that is activated by the power controller. In another embodiment, the apparatus further includes an irradiance sensor. In another embodiment, the apparatus further includes a temperature sensor. In another embodiment, the apparatus further includes a wind speed sensor. In another embodiment, the computing element includes a cryptocurrency mining device. In another embodiment, the power controller receives DC power from the DC bus bar. In another embodiment, the computing element includes a graphics processing unit (“GPU”). In another embodiment, the computing element includes a server.

Embodiments of the present invention also relate to a system with a solar array, an inverter, a power controller, and a cluster of computing elements—for example, servers, bitcoin miners (which can include for example S19 bitcoin miners), or other devices commonly used in data centers. The computing elements are not connected to the AC grid, but rather are powered via a behind the meter DC bus.

Embodiments of the present invention also relate to a solar panel energy allocation apparatus having a logic controller that is configured to receive as inputs a value that is indicative of a radiant flux striking a solar array, and a value representing an amount of power output by at least one inverter or a value from a power point controller; the logic controller configured to calculate a value representing clipped power; and a relay coupled to the logic controller, the logic controller configured to activate the relay to provide power that would otherwise be clipped from a direct current bus to at least one computing element. The controller receives as input a value representing an ambient temperature of the solar array The controller can include a network connection, which can optionally receive actual or estimated inverter output information, and/or input from an electrical grid. The logic controller can use information regarding total available power that can be produced by a solar array, an output of at least one inverter, and the input from the electrical grid to determine the value representing clipped power. The apparatus can also include a direct current to direct current power converter to receive power from the direct current bus.

Solar arrays have a maximum DC output power that is a function of an array's size, efficiency, temperature, and the radiant flux (irradiance) that strikes it. As previously mentioned, it is common practice to undersize an inverter relative to the maximum output of a coupled solar array; that is, the inverter's maximum input power is less than the array's maximum output power. This ratio of the array's maximum output power to the inverter's maximum input power is called the inverter load ratio, (“ILR”). FIG. 1 is a graph that illustrates how power is clipped when a solar array's output power exceeds an inverter's maximum input power.

Each computing element in the DC-coupled computing cluster preferably has a minimum and a maximum power consumption rate. Each also preferably has at least one processor with a programmable input voltage and/or a programmable clock frequency; both of these affect the overall power consumption of the computing elements.

In embodiments disclosed herein, the power controller preferably captures and allocates power that would otherwise be lost to clipping by:
periodically estimating the maximum power output of the solar array (in one embodiment, this can be done by using a measured value of radiant flux striking the array or by measuring maximum output from one or more cells or one or more panels and then extrapolating that to a corresponding value for the entire solar array), and (optionally) a measured value of the ambient temperature and wind speed (in one embodiment, the measured value of radiant flux can be an estimated and/or calculated amount of radiant flux, thus as used throughout this application, a calculated radiant flux can include an estimated radiant flux);
with each periodic estimate of the maximum power output of the solar array, applying a loss factor to calculate an estimated usable power output of the array (this can optionally include: a static loss factor that is based on soiling, panel degradation, wiring losses, etc. ; a value that is programmed or otherwise simply input by a user; and or dynamically learned during runtime-for example if we predicted an amount of clipped power, and consuming that amount caused the inverter power to drop by an amount-for example such that a relay is tripped, then the clipped power can be adjusted and the process repeated until it is observed to be accurate based on the inverter power not dropping more than some predetermined amount);
calculating an available clipped power value by subtracting the maximum power input of the inverter from the estimated usable power output of the array;
for each calculation of the available clipped power value, if the result is both positive and greater than the minimum power consumption rate of at least one computing element at a measured temperature, then:
(i) energizing a DC bus; and
   activate one or more of the plurality of computing elements and program the input voltage and/or clock frequency of each processor in each activated computing element so that the one or more activated computing elements consume an amount of power that is approximately equal to the clipped power value.

When the grid output of the inverter is reduced below an amount that it could otherwise produce from the solar array, (for example, during times of inverter malfunction, curtailment, low electricity prices, or other reasons), embodiments disclosed here also capture the otherwise-unusable power and direct it to the computing elements.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. For example, FIGS. 2 and 3 list some examples of components and/or a quantity thereof that can optionally be used; however, desirable results can be obtained when using different components and/or a different number of components than those shown in the figures), In the drawings:

FIG. 1 is a graph that illustrates clipped power in a system with an inverter loading ratio greater than 1, according to an embodiment of the present invention;

FIG. 2 is a diagram that illustrates one embodiment with a one or more solar arrays, one or more inverters, and a controller, according to an embodiment of the present invention;

FIG. 3 is a diagram that illustrates computing elements, DC/DC converters, and a disclosed power controller, according to an embodiment of the present invention; and

FIG. 4 is a flow chart that illustrates a disclosed power control method, according to an embodiment of the present invention.

### DETAILED DESCRIPTION OF THE INVENTION

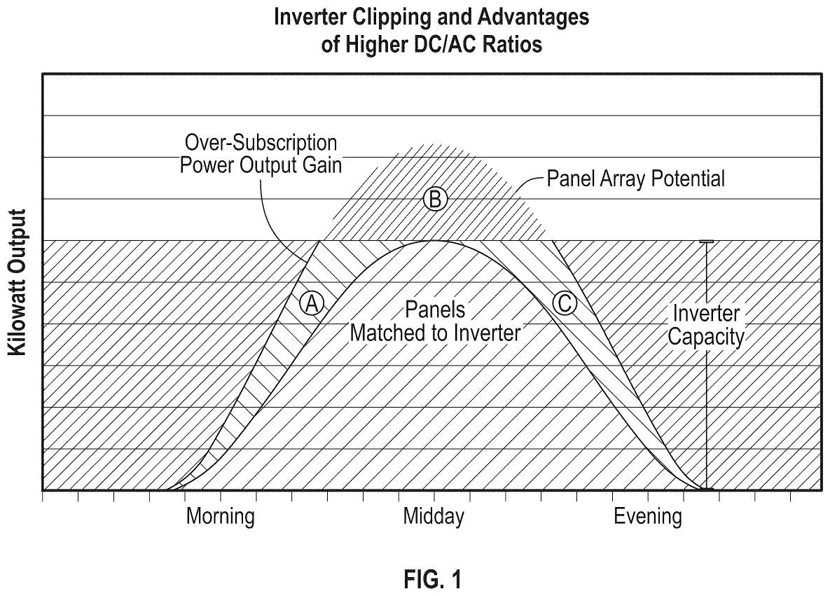

Referring now to the figures, FIG. 1 illustrates how power is clipped when a solar array's output power exceeds an inverter's maximum input power. In FIG. 1, regions A and C are the additional power that can be converted to AC by the inverter during non-peak sunlight hours (for example, morning and evening) when the panels are over-sized with respect to the inverter. This is often referred to as the “over-subscription”. Region B in FIG. 1 is the energy lost due to clipping because of this oversizing. However, as can be seen in the case where the panels are exactly matched to the inverter, the total energy generated is less than the case when it is oversized.

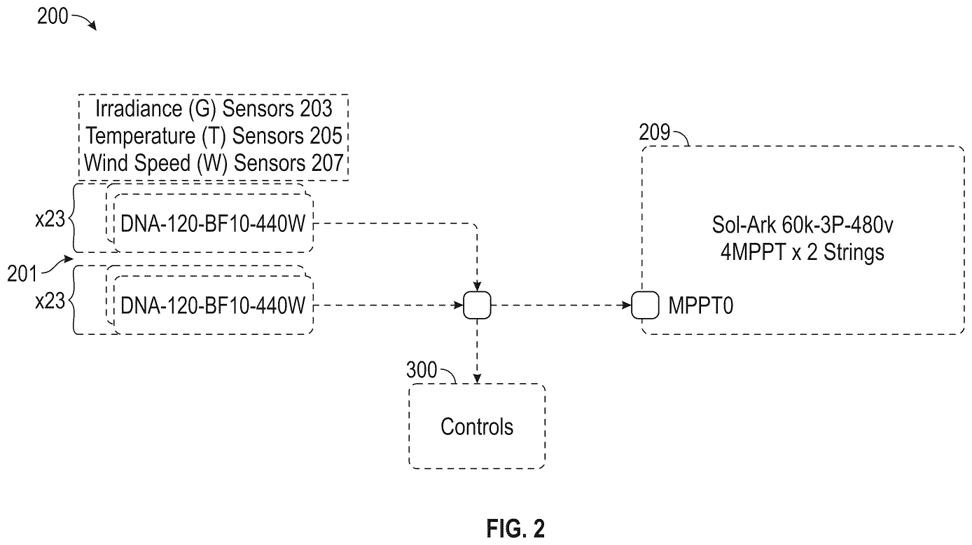

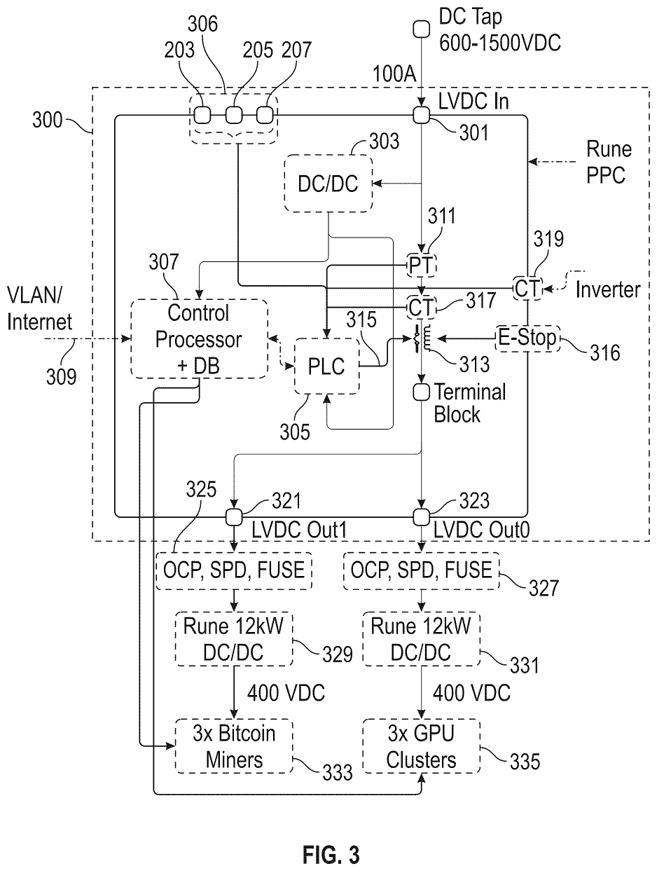

FIG. 2 is diagram that illustrates components of solar energy converting system 200 in one embodiment of the invention. Solar energy converting system 200 preferably includes one or more solar panel arrays 201. Co-located with solar panel arrays 201 are preferably one or more irradiance (“G”) sensors 203, one or more temperature (“T”) sensors 205, and one or more wind speed (“W”) sensors 207. Also included in solar energy converting system 200 are preferably one or more inverters 209, and controls 300 (which are described in more detail in FIG. 3).

Solar panel arrays 201 can be formed by connecting or otherwise inputting energy from any desired number of strings of solar panels. In addition, each of the strings can contain any desired number of panels. For example, as illustrated in FIG. 2, there can optionally be 2 strings, each containing 23 solar panels. Each solar panel array 201 is preferably controlled by controls 300 and in communication with inverter 209.

FIG. 3 provides further details of an embodiment of controls 300 that can be used, along with computing group 333 and computing group 335. Controls 300 can include terminal 301 that receives DC power (in this particular example, the voltage can optionally be about 600 volts of direct current (“VDC”) to about 1500 VDC, from solar panel arrays 201; and one or more direct current to direct current (“DC/DC”) converters 303 that preferably reduce the voltage to a lower and more useable voltage (which can optionally include for example about 24 volts at 90 watts—although any other desirable voltage and power level can be used) provide power to programmable logic controller (“PLC”) 305 and control processor+database 307. Although a PLC is most preferably used, it is important to understand that other components can be configured to perform the same functions as a PLC and thus the term “PLC” and/or “logic controller”, are used interchangeably and are intended to include any component or group of components that can perform the same function, including but not limited to one or more microcontrollers and/or microprocessors with associated circuitry, an application specific integrated circuit (ASIC) and/or one more logic chips. PLC 305 preferably receives (as inputs) data from irradiance sensors 203, temperature sensors 205, and/or wind speed sensors 207 via input terminal(s) 306. PLC 305 can also optionally receives a signal from a potential transformer(“PT”) sensor to calculate voltage 311, current sensor 317, which can optionally include for example a current transformers (“CT”) sensor can be used to generate an output that can be used to calculate power to the data center. In addition, a second CT sensor, sensor 319, can be used to calculate power going into the inverter. Control processor +database 307 preferably includes network connection 309 and receives actual (or estimated) inverter output 310, grid commands 312, and grid frequency information 314.

In one embodiment, controls 300 preferably includes relay 313. Relay 313 passes high voltage DC to terminals 321 and 323 when energized by control signal 315 from PLC 305. Computing groups 333 and 335 can be powered after the high voltage DC passes through overcurrent protection devices, surge protection devices, and/or fuses 325 and 327, which can be down-converted to lower voltage by DC/DC converters 329 and 331, and then can energize DC buses 337 and 339. This DC architecture provides several benefits, including, for example, the ability to capture clipped power and thus increase efficiency. DC-DC converters operate at up to 99% or more efficiency, whereas datacenters that operate on the AC side have multiple points of losses via the inverter, transformers, wire losses, etc. thus resulting in less than about 90% efficiency.

Computing groups 333 and 335 can include any desired computing elements, including but not limited to, one or more Bitcoin miners, graphics processing units (“GPU”), and/or servers. The computing elements within computing groups 333 and 335 preferably have a minimum and a maximum power consumption rate. Each computing element preferably includes at least one semiconductor chip (for example, a processor, memory, etc.)-most preferably having a programmable input voltage, a programmable clock frequency, and/or both. Operating temperature, clock frequency and input voltage each affect the overall power consumption of a semiconductor chip, and techniques for programming a semiconductor chip's clock frequency or input voltage are known and can be used.

In one embodiment, computing group 333 includes three independently controllable (S19) Bitcoin miners, and computing group 335 includes three independently controllable GPUs. Other embodiments can use different types or combinations of independently controllable computing elements, or the computing elements can be replaced with any device or group of devices with variable and programmable rates of electrical power consumption.

In one non-limiting example, computing group 333 can include a Bitcoin miner with dozens or even hundreds of semiconductor chips with programmable input voltages and clock frequencies; where power consumption of semiconductor chips is also a function of operating temperature. By selectively programming these voltages and frequencies, preferably at a measured operating temperature, each Bitcoin miner has a power consumption rate that that can range from, for example, about 1.8 thousand watts (“kW”) to about 4 kW. Therefore, by selecting the number of Bitcoin miners to operate (for example between one and three in this particular example) and the semiconductor chip input voltage and/or clock frequency for each, computing group 333 has a power consumption rate when operating that is programmable between about 1.8 kW and about 12 kW.

In one embodiment of controls 300, faults are preferably detected and treated as either a “soft” error or a “hard” error. If a soft error is detected, the system preferably restarts the current operation. If a hard error is detected, all computers are preferably disabled, and the system waits for a manual override. These soft and hard errors can optionally be referred to as “malfunctioning” computing elements.

Example fault conditions can include, but are not limited to, the following:
1. Communications failure and/or sensor read failure, which can be regarded as a “hard error;
2. When power to a computing group is turned ON, power input to the inverter (P_{INV}), or power output of the inverter (P_{AC}) drops by less than about 1% for 5 minutes (soft error);
3. When power to a computing group is turned ON, power input to the inverter (P_{INV}), or power output of the inverter (P_{AC}) drops by less than about 1% for 5 minutes and this happens 5 times within 60 minutes (hard error); and
5. More than some fraction of the computers within a computing group (for example, 10%) are not functioning, which can be regarded as a “hard error”.

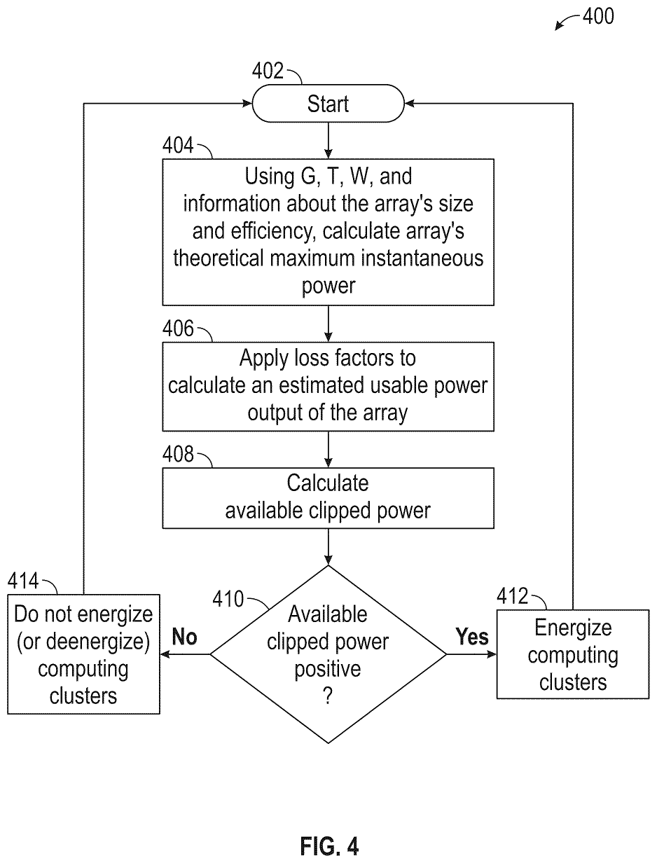

Referring now to FIG. 4 with occasional reference to FIG. 2, process 400 illustrates an example of how the disclosed system provides DC power to computing groups 333 and 335 when solar panel arrays 201 generate more power than inverter 209 is capable of converting to DC. In one embodiment, after process 400 begins at start 402, step 404 calculates the maximum total power output of solar panel arrays 201. The calculation in step 404 preferably uses a measured or calculated value of irradiance/radiant flux striking the array. However, any other way of estimating or otherwise determining a maximum power output for an array under a current set of environmental and/or geographical conditions can be used. For example, by measuring the total output of one or more solar cells or one or more solar panels and measuring the output of it-particularly when the one or more cells or panels are at or near (for example within less than one mile and more preferably within less than 100 yards and most preferably physically coupled to panel arrays 201). Then based on the output of the one or more cells or panels, performing a calculation to extrapolate or otherwise relate that output power to the output potential of the entire one or more panel arrays 201. Thus, the use of a reference cell(s) or panel(s) to calculate the estimated output power of a panel array can be used to estimate a maximum power output of solar arrays 201. Thus, in one embodiment, the one or more reference cells or one or more reference panels can themselves be regarded as one or more sensors.

Optionally, the calculation in step 404 can use a measured value of the temperature of the array. Optionally, the calculation in step 404 can use a measured value of wind speed at the array from irradiance sensors 203, temperature sensors 205, wind speed sensors 207, and other array characteristics (for example, the size and efficiency of the array) to arrive at a maximum power output of the array under those irradiance, temperature, and wind speed conditions. The National Renewable Energy Lab's System Advisor Model (“SAM”) provides this functionality, and in one embodiment, look-up tables based on SAM and the characteristics of solar panel arrays 201 can be stored in control processor +database 307. In another embodiment, step 404 can be performed simply by measuring irradiance or the value of a reference cell or panel, and optionally temperature at the array, and then calculating the array's maximum output power using the array manufacturer's published power function of irradiance and temperature.

Once the maximum total power output of solar arrays is known, step 406 can be used to estimate the actual amount of usable power available to inverter 209 and computing groups 333 and 335 by applying one or more loss factors. Loss factors can include, but are not limited to, a loss factor related to resistive (“I ²R”) losses in the array itself and in connection cables, a loss factor based on dust and/or debris buildup on the panels, a loss factor related to panel aging, a loss factor related to any downstream DC/DC conversions that must be performed, a loss factor that is calculated based on previous measured losses, and/or a combination thereof.

At step 408, an available power value is calculated. If the inverter is functioning properly and there are no other reasons for restricting power output to the grid (for example, curtailment commands from a grid operator, Locational Marginal Price (“LMP”) for electricity that make supplying power to the grid uneconomic, or ancillary services obligations (for example, grid frequency regulation), then available power is equal to the clipped power. The clipped power can be calculated by subtracting the known maximum rated input power of the inverter from the estimated usable power output of the array.

If the inverter is shut down because:
(a) it is malfunctioning (and therefore not providing power to the grid);
(b) the current LMP of electricity would make supplying power to the grid uneconomic;
(c) the system (controls 300) receives a curtailment command from a grid operator that indicates complete curtailment of grid output; and/or
(d) the system (controls 300) reduces its power output to the grid because its ancillary services obligations, including grid frequency regulation, cease grid output (as is possible when a measured grid frequency rises above a predefined threshold),
   then the available power is equal to the estimated usable power output of the array. Note that in case (d), grid frequency information can be received from the inverter.

If the inverter is functioning but providing less power to the grid than its maximum rated output because:
(a) the system (controls 300) receives a curtailment command from the grid operator that specifies a maximum, non-zero curtailed output to the grid; or
(b) the system (controls 300) reduces its power output to the grid because its ancillary services obligations, including grid frequency regulation, stimulate reduced (but not zero) grid output power;
   then the available power is calculated by subtracting an estimated or actual power flow through the inverter (equal to the inverter's actual grid output plus estimated or actual losses from the DC-AC conversion) from the estimated usable power output of the array.

Step 410 is a decision point: for each calculation of the available power, if the result is both positive and greater than the minimum power consumption rate of at least one computing element in computing groups 333 and 335 at a measured temperature, then, at step 412:
(i) energize the DC bus that powers computing groups 333 and 335; and
(ii) activate one or more one or more computing elements within computing groups 333 and 335, and program the input voltage and/or clock frequency of one or more semiconductor chips within each computing element so that the one or more activated computing elements consume an amount of power that is approximately equal to the available power value.
   Otherwise, at step 414, do not energize (or de-energize) the DC bus that powers computing groups 333 and 335.

After both steps 412 and 414, process 400 returns to start 402 and repeats the cycle. In one embodiment, process 400 is preferably repeated once per second, but this duration can be adjusted based on the preferences of the operator of the solar plant.

The preceding examples can be repeated with similar success by substituting the generically or specifically described components and/or operating conditions of embodiments of the present invention for those used in the preceding examples.

Optionally, embodiments of the present invention can include a general or specific purpose computer or distributed system programmed with computer software implementing steps described above, which computer software may be in any appropriate computer language, including but not limited to C, C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

The terms, “a”, “an”, “the”, and “said” mean “one or more” unless context explicitly dictates otherwise. Note that in the specification and claims, “about”, “approximately”, and/or “substantially” means within twenty percent (20%) of the amount, value, or condition given.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A method for allocating power to power consuming elements comprising the steps of:
estimating a maximum power output for a solar array;
calculating a loss factor for the solar array;
determining usable power output of the solar array based on the estimated maximum power output of the solar array and the calculated loss factor;
calculating an available power value by at least periodically subtracting an estimated or actual power flow through a grid-connected inverter from the determined usable power output of the solar array;
for each calculation of the available power value, if the result is both positive and greater than a minimum power consumption rate of at least one power consuming element, then:
supplying power to one or more of the power consuming elements; and
causing the one or more of the power consuming elements to consume a predetermined amount of power.

2. The method of claim 1 wherein estimating the maximum power output for a solar array comprises measuring or estimating radiant flux striking the solar array.

3. The method of claim 1 wherein the estimated or actual power flow through the grid-connected inverter is equal to the grid-connected inverter's actual grid output plus estimated or actual losses from a DC-AC conversion performed by the inverter.

4. The method of claim 1 wherein an estimate of power flow through the grid-connected inverter is based, at least in part, on a curtailment command received from a grid operator.

5. The method of claim 1 wherein an estimate of power flow through the grid-connected inverter is based, at least in part, on a measured value of grid frequency.

6. The method of claim 1 wherein an estimate of power flow through the grid-connected inverter is based, at least in part, on a calculation related to a current locational marginal price of electricity.

7. The method of claim 1 wherein the predetermined amount of power is at least substantially equal to the clipped power value.

8. A solar panel energy allocation apparatus, comprising:
a solar panel array;
an alternating current (“AC”) bus;
a direct current (“DC”) bus;
an inverter disposed between said AC bus and said DC bus;
a power controller calculating a clipped power value, wherein the clipped power value is calculated by at least periodically subtracting a maximum power input of said inverter from an estimated usable power output of said solar panel array; and
a computing element that is powered by said DC bus based on an output of said power controller, such that said computing element uses at least some power that would otherwise be clipped.

9. The apparatus of claim 8, further comprising an irradiance sensor.

10. The apparatus of claim 8, further comprising a temperature sensor.

11. The apparatus of claim 8, further comprising a wind speed sensor.

12. The apparatus of claim 8, wherein said computing element comprises a cryptocurrency mining device.

13. The apparatus of claim 8, wherein said power controller receives DC power from said DC bus.
